(19) United States
(12) Patent Application Publication
(10) Pub. No.: US 2021/0230937 A1
(43) Pub. Date: Jul. 29, 2021

(54) LOCK DOWN WINDOW COVERING

(71) Applicant: Master Marketing International, Inc. d/b/a MagnetStreet, Carol Stream, IL (US)

(72) Inventor: Kendall Arnold OLSON, New Brighton, MN (US)

(21) Appl. No.: 17/155,125

(22) Filed: Jan. 22, 2021

Related U.S. Application Data
(60) Provisional application No. 62/965,039, filed on Jan. 23, 2020.

(51) Int. Cl. E06B 9/24; E06B 5/10

(52) U.S. Cl. CPC E06B 9/24; E06B 5/10

(57) ABSTRACT

A system for protecting a room during an emergency situation. Such a system includes a see-through opening and a device including a sheet of magnetic material. The sheet of magnetic material is bounded by a plurality of edges and has an anterior surface and an opposing posterior surface. The posterior surface is configured to engage the opening. The device is moveable between a first position wherein the device obstructs vision through the opening and a second position wherein the device does not obstruct vision through the opening.

### CROSS-REFERENCE TO RELATED APPLICATIONS

This application claims the priority benefit of U.S. Provisional Patent Application No. 62/965,039, filed on Jan. 23, 2020, the disclosure of which is incorporated herein by reference in its entirety.

### BACKGROUND

To promote the safety of those using public buildings, especially public schools, during active shooter situations, several methods are utilized for obstructing view into a respective room. However, many existing systems and methods do not allow for rapidly covering windows or doors to obstruct vision into the room. Current methods may require an individual to create a barrier to obstruct view on the fly, rather than using a preexisting object. Moreover, there are varying sizes of openings to be covered or obstructed. Existing systems do not allow for coverage of various sizes of openings.

Therefore, there exists a need for a device and method which allow individuals to quickly and efficiently cover doors and windows in an active shooter situation to obstruct view into the room.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a front view of a lockdown magnet according to an embodiment of the present disclosure;

FIG. 2 is a rear view of a lockdown magnet according to an embodiment of the present disclosure;

FIG. 3 is a side perspective view of a lockdown magnet according to an embodiment of the present disclosure; and

FIG. 4 is a front view of a lockdown magnet engaged with a door for storage according to an embodiment of the present disclosure;

FIG. 5 is a front view of lockdown magnet engaged with a door, covering an opening according to an embodiment of the present disclosure;

FIG. 6 is a rear view of lockdown magnet with adhesive for attachment to a non-magnetic surface according to an embodiment of the present disclosure;

FIG. 7 is a flowchart of a method of using a lockdown magnet to cover an opening according to an embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

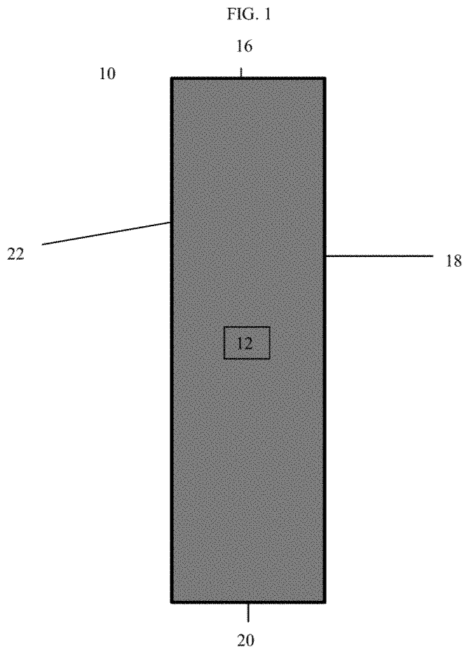

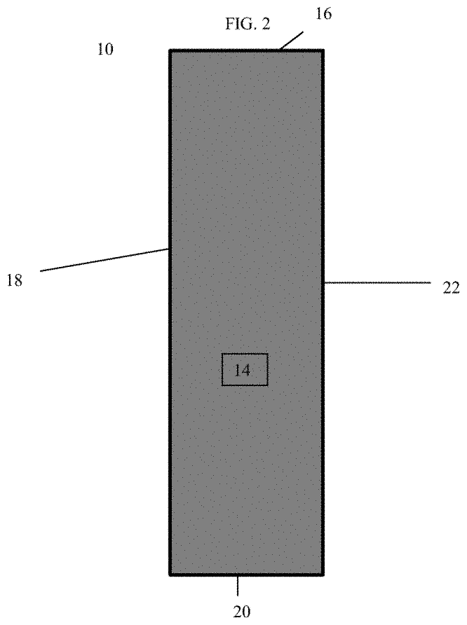

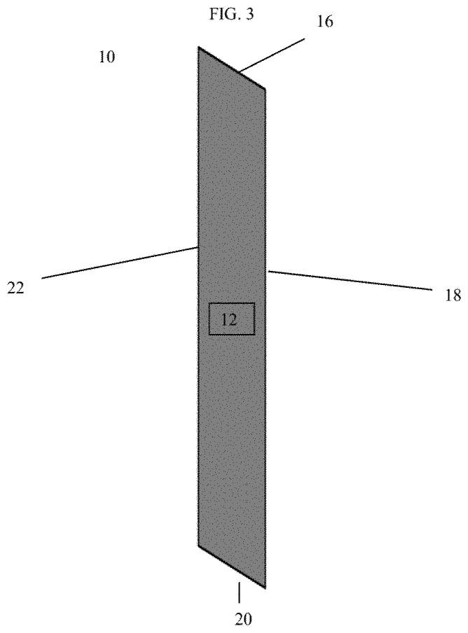

Referring now to the drawings, FIGS. 1-3 show a lockdown magnet 10 according to at least one embodiment of the present disclosure. As shown in FIGS. 1-3, the lockdown magnet 10 comprises an anterior surface 12 and a posterior surface 14. The lockdown magnet is bounded by a first edge 16, a second edge 18, a third edge 20 and a fourth edge 22 according to at least one embodiment of the present disclosure. According to at least one embodiment of the present disclosure, the lockdown magnet 10 is constructed as a single piece of magnetic material. According to at least one embodiment of the present disclosure the anterior surface 12 contains any desired indicia, including text, image, or combination of text and images. According to at least one embodiment of the present disclosure the anterior surface may contain school names and logos, teacher's names, classroom names, or any other desired designs. According to at least one embodiment of the present disclosure the lockdown magnet 10 comprises more than one layer wherein one of the layers comprises a laminated surface and one layer comprises a magnetic layer, wherein the laminated surface may contain any desired indicia.

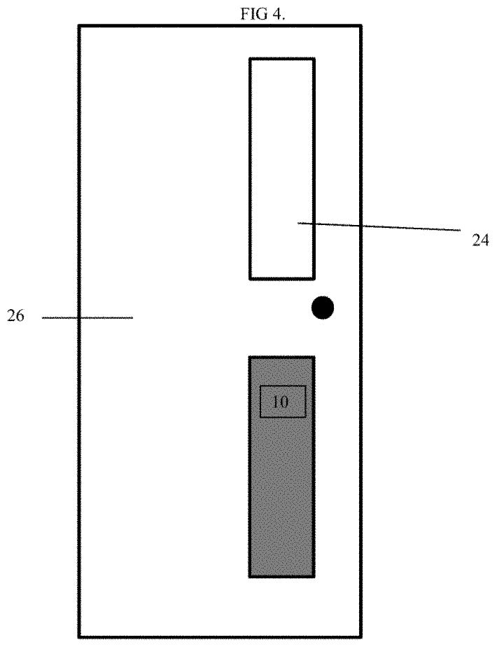

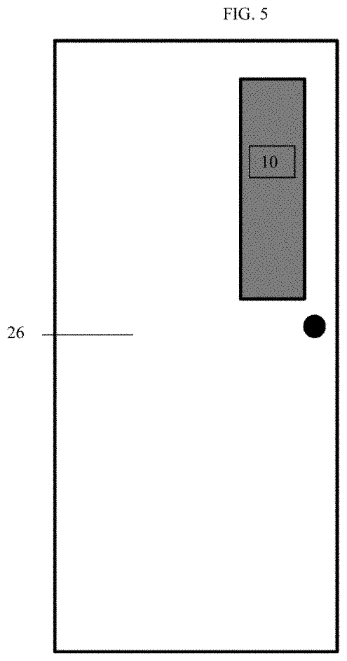

FIGS. 4-5 show a lockdown magnet 10 engaged with a door 26 according to at least one embodiment of the present disclosure. FIG. 4 shows a lockdown magnet 10 in storage near an opening 24 on the door 26 according to at least one embodiment of the present disclosure. FIG. 5 shows a lockdown magnet 10 engaged with the opening 24 on the door 26 according to at least one embodiment of the present disclosure. According to at least one embodiment of the present disclosure, the opening 24 is a window. According to at least one embodiment of the present disclosure, when the lockdown magnet 10 is engaged with the opening 24 it functions to obstruct vision through the opening. According to at least one embodiment of the present disclosure, when the lockdown magnet 10 is not engaged with the opening 24, it serves decorative purpose while not obstructing vision through the opening 24. According to at least one embodiment of the present disclosure, the opening 24 is located on a door 26. According to at least one embodiment of the present disclosure, the opening 24 is adjacent to a door 26. According to at least one embodiment of the present disclosure, the opening 24 is a free standing opening, such as a window. According to at least one embodiment of the present disclosure, the lockdown magnet 10 is sized to cover the opening 24.

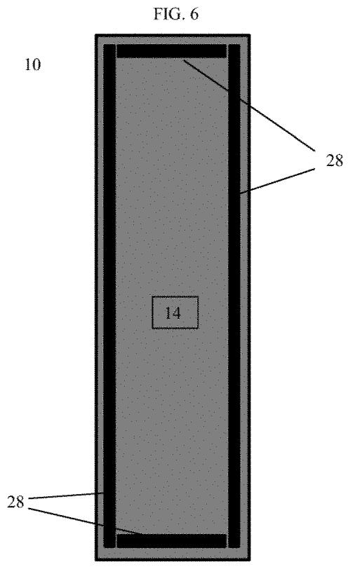

FIG. 6 shows a lockdown magnet 10 with adhesive material 28 removably attached to the posterior surface 14 according to at least one embodiment of the present disclosure. The adhesive material 28 allows attachment of the lockdown magnet 10 to any non-magnetic surface, according to at least one embodiment of the present disclosure.

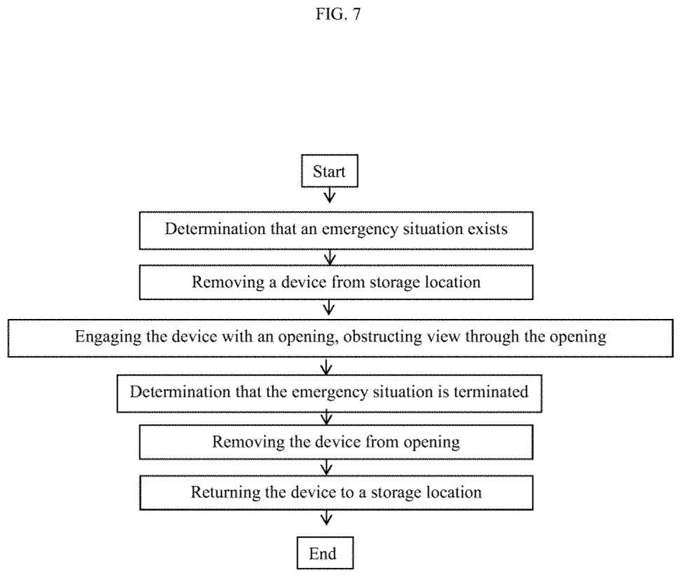

FIG. 7 is a flowchart of a method for using and positioning a lockdown magnet 10 over an opening 24. After determining that an active shooter situation exists, the lockdown magnet 10 is removed from a storage location according to the present disclosure. According to the present disclosure, the lockdown magnet 10 is placed over the opening 24. When the active shooter situation is terminated, the lockdown magnet 10 is removed from the opening 24, according to the present disclosure. According to the present disclosure, the lockdown magnet 10 is then returned to a storage location.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. A system for protecting a room during an emergency situation, the system comprising:
a see-through opening; and
a device, the device comprising a sheet of magnetic material, the sheet of magnetic material being bounded by a plurality of edges and having an anterior surface and an opposing posterior surface,
wherein the posterior surface is configured to engage the opening,
the device being moveable between a first position wherein the device obstructs vision through the opening and a second position wherein the device does not obstruct vision through the opening.

2. The system of claim 1, wherein the device is opaque.

3. The system of claim 1, wherein one or more of the anterior surface or the posterior surface displays an indicia, such as school names and logos, teacher's names, classroom names, or any other desired designs.

4. The system of claim 1, wherein the magnet comprises three or more edges.

5. The system of claim 1, wherein the magnet comprises four or more edges.

6. The system of claim 1, wherein the opening comprises a door.

7. The system of claim 1, wherein the opening comprises a window.

8. A method for protecting a room during an emergency situation, comprising:
determining that an emergency situation exists;
removing a device configured to engage an opening in the room from a storage location;
engaging the device with the opening, obstructing vision through the opening;
determining that the emergency situation is terminated;
removing the device from the opening; and
returning the device to the storage location,
wherein the device comprises a sheet of magnetic material, the sheet of magnetic material being bounded by a plurality of edges and having an anterior surface and an opposing posterior surface.

9. The method of claim 8, wherein the device is opaque.

10. The method of claim 8, wherein one or more of the anterior surface or the posterior surface displays an indicia, such as school names and logos, teacher's names, classroom names, or any other desired designs.

11. The method of claim 8, wherein the magnet comprises three or more edges.

12. The method of claim 8, wherein the magnet comprises four or more edges.

13. The method of claim 8, wherein the opening comprises a door.

14. The method of claim 8, wherein the opening comprises a window.
